(19) United States
(12) Patent Application Publication
(10) Pub. No.: US 2002/0067267 A1
(43) Pub. Date: Jun. 6, 2002

(54) PACKAGE IDENTIFICATION SYSTEM

(76) Inventor: Richard Kirkham, Loveland, OH (US)

Correspondence Address: Gibbons, Del Deo, Dolan,, Griffinger & Vecchione, 1 Riverfront Plaza, Newark, NJ, 07102, US

(21) Appl. No.: 09/809,716

(22) Filed: Mar. 15, 2001

Related U.S. Application Data
(60) Provisional application No. 60/189,596, filed on Mar. 15, 2000.

(51) Int. Cl. G08B 13/14

(52) U.S. Cl. 340/572.7; 340/572.1; 340/568.1; 340/571; 340/10.1

(57) ABSTRACT

### Abstract of Disclosure

The present invention is embodied in a package for protecting and displaying goods, the package includes a wireless smart package assembly and a Radio Frequency Identification (RFID) tag. The assembly comprises a package having at least one sheet of material adapted to support a product during the shipment and storage of the product. An electrically conductive material distributed along a portion of the sheet so as to form a non-planar antenna. The non-planar antenna may be configured to form a corner antenna or an array of spaced-apart dipole antennas. The invention when used with a passive RFID tag includes a power source within the RFID tag that allows for a one-time transmit capability.

### Cross Reference to Related Applications

This application claims priority from U. S. Provisional Application No. 60/189,694 filed on March 15, 2000 and U.S. Provisional Application No. 60/189, 596 filed on March 15, 2000 and which are hereby incorporated by reference.

### Background of Invention

### Field of the Invention

This invention relates to the field of packaging, and more particularly to systems for interfacing packages with a computer system.

### Description of the Related Art

With the advent of modern product distribution scenarios in which low inventories and distribution transportation schemes require greater reliance on the ability to ensure the safe and rapid delivery of goods, the need has arisen to track the security and integrity of the goods throughout the chain of distribution. Solutions to such problems need to focus on ways to track the location of the goods and to identify when the security and integrity of the goods are in question. Presently, the tracking of goods is accomplished partially during transit to allow for the tracking of various shipments. Often the goods identified as a single shipment are tracked collectively and can be identified by a single tracking or shipping number. Items lost from the shipment during transit cannot be monitored during shipment and are not identified until the shipment arrives. Such losses can be critical when inventories are kept at a minimum level resulting in the potential for down time and lost sales.

Moreover, solutions for protecting the security and integrity of the goods relies upon the packaging in which manually conducted visual inspection of the packaging is used to determine the integrity of the goods contained therein. Where expensive goods are enclosed in the packaging, seals are implemented to further aide in the visual inspection of the packaging. However, such solutions merely relate back to a single form of inspection, namely, the visual inspection.

Thus, the need exists for ways to track individual units of goods while providing other solutions for maintaining the integrity and security of the goods during shipment.

### Summary of Invention

The present invention is embodied in a package for protecting and displaying goods, the package includes a wireless smart package assembly and a Radio Frequency Identification (RFID) tag. The assembly comprises a package having at least one sheet of material adapted to support a product during the shipment and storage of the product. An electrically conductive material is distributed along a portion of the sheet so as to form a non-planar antenna.

One embodiment of the assembly includes a package that is adapted to surround the product. The sheet is folded to form multiple interior and exterior surfaces to surround the product. The electrically conductive material is arranged to form a non-planar layer and is adapted to traverse at least one fold and cover a portion of at least two of the surfaces.

Another embodiment of the assembly relates to a product that is a roll of paper. The package is a cylindrical core having an inner surface surrounding a hollow center and an outer surface about which the paper is rolled. The electrically conductive material is arranged to form a ring of spaced-apart linear dipoles about the circumference of said core. The dipoles are connected to a combiner circuit to form a dipole antenna array.

Yet another embodiment of the invention utilizies a passive RFID tag adapted with a power source to operate with a one time transmit capability, wherein a passive RFID tag in response to a query from an interrogator actively communicates identifying data.

### Brief Description of Drawings

A more complete understanding of the present invention may be obtained from consideration of the following description in conjunction with the drawings in which:

FIG. 1 is a functional overview of a radio frequency identification system;

FIG. 2 is a diagrammatic view of an RFID tag;

FIG. 3a and 3b are details of nonplanar RFID antennas;

FIG. 4a is a schematic of an inventory monitoring system of the present invention that has two dipoles arrayed together, combined with a Wilkinson two way power combiner;

FIG. 4b is a schematic of an alternative inventory monitoring system of the present invention that has two dipoles arrayed together combined with a Wilkinson two way power combiner and a chip resistor with a microstrip line;

FIG. 5 is a top view of the inventory monitoring system of FIG. 4a;

FIG. 6 is a schematic showing vertical dipole antennas arrayed in a circular pattern on a cylindrical core;

FIG. 7 is a top view of the cylindrical core of FIG. 6;

FIG. 8 is a schematic representation of a wave signal as it travels through a medium;

FIG. 9 is a functional overview a system employing the present invention; and

FIG. 10 is a diagrammatic view of an RFID tag with one time transmit capabilities.

### Detailed Description of Various Illustrative Embodiments

Although the present invention is particularly well suited for monitoring packages in transit, and shall be so described, the present invention is equally well suited for use in control and tracking of expensive and/or stolen goods. And, the present invention is equally well suited for use in inventory control and tracking while at a stationary location.

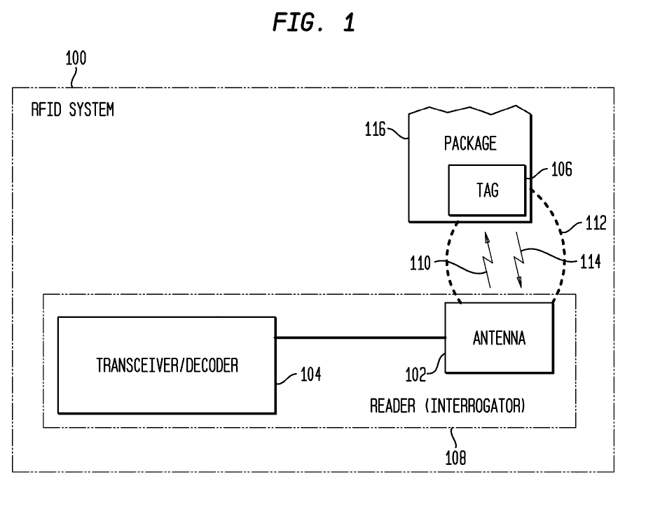

With reference to the figures for purposes of illustration, a Radio Frequency Identification (RFID) system 100 (FIG. 1) essentially consists of three components: an interrogator antenna or coil 102; a transceiver (with decoder) 104; and a transponder, commonly called an RF or RFID tag 106 programmed to hold and exchange information or data.

The interrogator antenna 102 emits radio signals to activate the RFID tag 106 and to read and write data to the RFID tag 106. Interrogator antennas come in a variety of shapes and sizes. A common form of interrogator antenna is built into a doorway of a store or other entryway to receive tag data from persons or things passing through the door. In such an example, RFID tags placed on goods, and when in range of the interrogator antenna, cause an alarm to sound. The electromagnetic field produced by the interrogator antenna 102 can be constantly present when multiple tags 106 are expected continually. If constant interrogation is not required, a sensor device used with the transceiver 104 can activate the field.

Often the antenna 102 is configured with the transceiver/decoder 104 as a single unit to become a reader or interrogator 108, which can be configured either as a handheld or a fixed-mount device. The reader 108 emits radio waves 110 in ranges of anywhere from one inch to 100 feet or more, depending upon its power output and the radio frequency used. When an RFID tag 106 passes through the electromagnetic zone 112, the tag detects the reader"s activation signal, and responds by emitting radio waves 114. The reader 108 decodes the data encoded in the tag"s integrated circuit and the data is passed to a host computer for processing.

RFID tags 106 come in a wide variety of shapes and sizes. RFID tags 106 are categorized as either active or passive. Active RFID tags 106 are powered by an internal battery and are typically read/write, i.e., tag data can be rewritten and/or modified. An active tag"s memory size varies according to application requirements; some systems operate with up to 1MB of memory. In a typical read/write RFID system 100, a tag 106 can provide a set of instructions, and the tag 106 can receive information. This encoded data then becomes part of the history of the tagged product 116. The battery-supplied power of an active tag generally gives it a longer read range. The trade off is greater size, greater cost, and a limited operational life.

Passive RFID tags 106 operate without a separate external power source and obtain operating power generated from the reader 104. Passive tags 106 are consequently much lighter than active tags 106, less expensive, and offer a virtually unlimited operational lifetime. The trade off is that passive tags 106 have shorter read ranges than active tags and require a higher-powered reader.

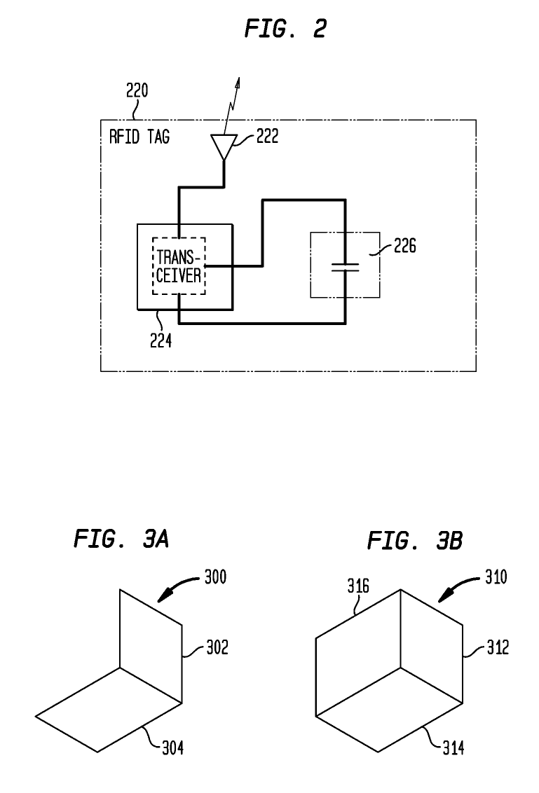

Referring to FIG. 2 there can be seen a detailed functional overview of the RFID tag. An RFID tag 220 is comprised of an antenna 222, a transponder 224 and an energy storage device 226. The RFID tag 220 in response to being interrogated transmits a response to the interrogation. Portions of the RFID tag 220, such as the antenna 222 and the energy storage device 226 may be printed on a package or label. The transponder 224 can be manufactured from an application specific integrated circuit (ASIC) or other suitable technology which is known to those skilled in the art. In response to a predetermined form or query or code the transponder 224 activates a transceiver 230.

Read-only tags are typically passive and are programmed with a unique set of data, usually a 32 to 128 bit string that cannot be modified and includes identifying information about the product the tag is attached to. Read-only tags most often operate as a key or index into a database, in the same way as linear barcodes reference a database containing modifiable product-specific information.

RFID systems also vary according to frequency ranges. Low-frequency, 30 kHz to 500 kHz, systems have short reading ranges and lower system costs. Low-frequency devices are most commonly used in security access, asset tracking, and animal identification applications. High-frequency, 850 mHz to 950 mHz and 2.4 gHz to 2.5 gHz, systems, offer long read ranges typically greater than 90 feet and high reading speeds.

The significant advantage of all types of RFID systems is the non-contact, non-line-of-sight nature of the technology. Tags can be read through a variety of substances such as snow, fog, ice, paint, crusted grime, and other visually and environmentally challenging conditions, where barcodes or other optically read technologies would be problematic. RFID tags can also be read in such challenging conditions at remarkable speeds, responding in less than 100 milliseconds.

The range that can be achieved in an RFID system is essentially determined by: power available at the reader/interrogator to communicate with the tag(s); power available within the tag to respond; and environmental conditions and structures.

Although the level of available power is the primary determinant of range, the manner and efficiency with which that power is employed also influences the range. The field or wave delivered from an antenna extends into the space adjacent to it and its strength diminishes with respect to distance. The antenna design will determine the shape of the field or propagation wave delivered, so that range will also be influenced by the angle subtended between the tag and antenna.

In open space, free of any obstructions or absorption mechanisms, the strength of the field reduces in inverse proportion to the square of the distance. For a wave propagating through a region in which reflections can arise from the ground and from obstacles, the reduction in strength can vary quite considerably, in some cases as an inverse fourth power of the distance. Where different paths arise in this way the phenomenon is known as "multi-path attenuation". At higher frequencies absorption due to the presence of moisture can further influence range. It is therefore important in many applications to determine how the environment, internal or external, can influence the range of communication. Where a number of reflective metal "obstacles" are encountered within the environment of the RFID tag to be considered, and can vary in number from time to time, it is desirable to consider the implications of such changes through an appropriate environmental evaluation.

In evaluating the environmental considerations of the RFID tag, the product identified or associated with the RFID tag is considered. Typically the goods to be delivered or stored dictate the packaging used to store product and display the goods. For example, expensive liquors may be shipped in a decorative decanter that is stored within a decorative box.

The placement of the RFID tag may consider placement of the tag within the box and/or on the bottle. The location may require considerations of aesthetics as well as functional capabilities. Providing a functional RFID tag considers application of the antenna relative to the packaging. In other applications the related packaging may have a completely different configuration. For example, in the shipment of large rolls of paper for commercial use, the related packaging may include the core at the center of the roll. Again, providing a functional RFID tag considers application of the antenna relative to the paper core.

RFID Non-planar AntennasAdvantageously, the present invention provides antenna configurations that can be adapted to various packaging materials and configurations to expand the use of RFID tags in various applications while maintaining a low cost product.

1. RFID Corner AntennaReferring to FIGs. 3a and 3b there is shown two representative embodiments of nonplanar RFID antennas adapted for use with an RFID tag.. The nonplanar RFID antenna increases the field of view of the antenna and thus the likelihood of detection by a reader. Spherical antenna coverage is reduced by package blockage. The nonplanar RFID antennas 300 and 310 can be excited with either linear or circular polarization. The specific length and width of the nonplanar RFID antennas is a function of frequency, application, package size, package material and package content. Bandwidth is increased by resistively loading the conductive medium which comprises the antenna element.

FIG. 3a shows a nonplanar RFID antenna 300 comprised of two planar surfaces 302 and 304 which are electrically coupled to resemble an angle bracket. FIG. 3b shows a nonplanar RFID antenna 310 comprised of three planar surfaces 312, 314 and 316 which are electrically coupled to resemble a corner bracket. The nonplanar RFID antennas 300 and/or 310 can be located at one edge or corner of the package as well as at multiple edges or corners of the packages. The use of multiple nonplanar RFID antennas 300 and/or 310 improves the field of view of the coupled antennas over that of a single RFID antenna 300 and/or 310. Multiple RFID antennas 300 and/or 310 are electrically coupled and may be printed directly on the package or on a label which is attached to the package. The corner antenna is preferably used with a wireless smart package assembly in which a package, formed from one or more sheets of material such as plastic, cardboard, paper, glass, is manufactured to enclose a product to protect and/or display the product. The antenna is formed from an electrically conductive layer which covers a portion of the package material. The layer is preferably formed on the interior surface of the package so as not to detract from the protective aesthetic aspects of the package. In other instances the layer may be applied to the outside of the package, but such an application would involve consideration of the protective and aesthetic features in connection with potential harm to the layer and operation of the layer.

Where the package material is configured to form a box, the electrically conductive layer may overlie multiple surfaces and may extend over an entire corner of the box. The size and shape of the layer is configured by width and length along the package surfaces in proportion to considerations such as the size of the package, the material used to form the package, the intended use of the RFID tag, i.e., as an active or passive device. Furthermore, the material used in the product contained in the package and the operating frequency of the antenna also affect the length and width of the layer. The layer preferably has a thickness proportional to the selected range and radiating efficiency of the RFID system.

The antenna may be uses with RFID tag transceivers capable of excitation in the form of linear and circular. Preferably, the antenna is adapted to operate with a 5% VSWR bandwidth. However, the VSWR bandwidth may be increased by resistively loading the electrically conductive layer. The layer is preferably in the form of an electrically conductive ink or paint that may be affixed by printing or painting. Alternatively, the layer may be formed by coper metalization.

2. RFID ANTENNA ARRAYDetecting attributes of physical products contained in packages, such as may be required when monitoring and tracking inventory, is a major concern to most businesses. The present invention provides a system that is designed to detect packaged product attributes and, particularly, to monitor inventory in an accurate, quick, and efficient manner. The system is comprised of one or more transponders, one or more readers, and one or more antennas. Prior art electronic systems used to track inventory typically do not have a significant range capability, since typical transponders used in the prior art do not provide a sufficient gain for transmitting data any great distance.

One or more transponders or tags may be utilized in connection with the present embodiment of the present invention. Data signals coded with unique identification information carried by each transponder are transmitted from the transponder to one or more readers. The information transmitted may, for example, relate to the presence of, or location of or other attributes of a product. A passive transponder, which does not require a separate power source, or an active transponder that has an internal power source, e.g. a battery, may be used. Preferably, a passive transponder is used in the system. Passive transponders have the advantages of being less expensive, lighter in weight, and longer lasting than active transponders. However, a passive transponder generally is associated with a shorter operational range of use (transmission distance) than an active transponder.

The gain of a transponder can be increased so that the power associated with the signal transmitted from the transponder is greater. For each 3 dB of additional gain associated with the transponder, the transmission range increases by about a factor of 2. In the system of the present invention, adjustments in the gain for the transponder by altering power is limited by the power standards for compliance with FCC, Part 15.

Alternative solutions for increasing the gain of the transponder can be accomplished by reducing loss in the Radio Frequency Integrated Circuit (RFIC), or increasing the operational size of an antenna that is coupled to the RFIC, or a combination of both. In one arrangement according to the present invention, the gain of the system is increased by arraying two or more dipoles (antennas) together in a rectangular, triangular, or hexagonal lattice configuration.

The half-power beamwidth (HPBW) is approximately 60° for a λ/2 dipole. By arraying two or more dipoles together, the gain is increased. The outputs from the arrayed dipoles are combined with a power combiner circuit. A power combiner circuit of the type suitable for this purpose is a Wilkinson power combiner/divider type circuit. The Wilkinson circuit uses a resistor, preferably embodied on an integrated circuit chip, and can be used to connect different numbers of dipoles together by using several layers of Wilkinson circuits.

The present invention also contemplates the use of one or more readers. A reader communicates with a transponder to effect data transfer. A reader also generates an electric field, from which the transponder derives power. The type of reader that is used in the system will depend upon the transponder that is used.

One or more antennas are required for the present embodiment of the present invention. Antennas (e.g. dipoles) serve as relay points between transponder and reader. An antenna produces an electromagnetic field that may be continuously present, where there are multiple transponders, or the electromagnetic field may be intermittently present, depending upon the needs of the system.

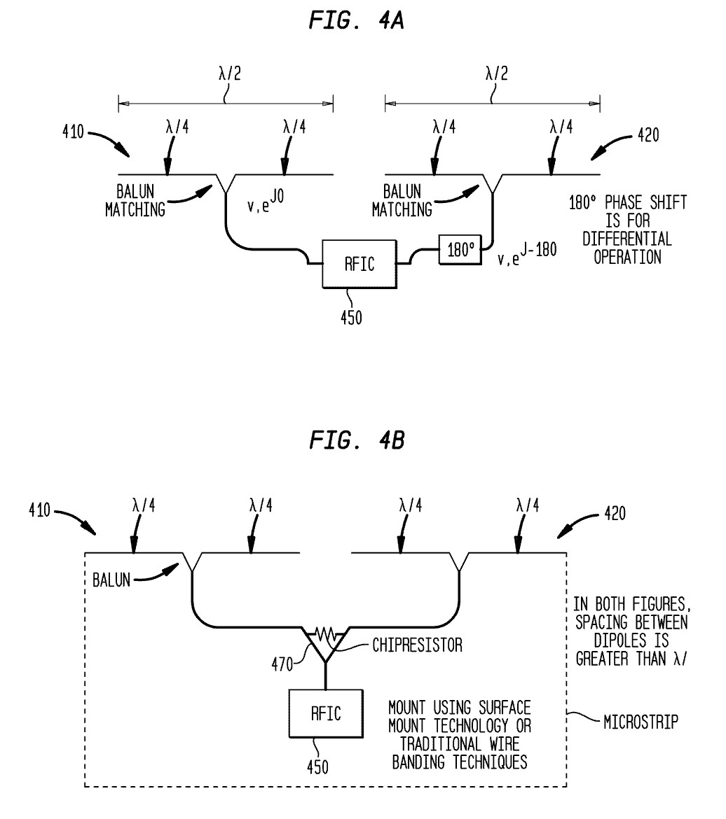

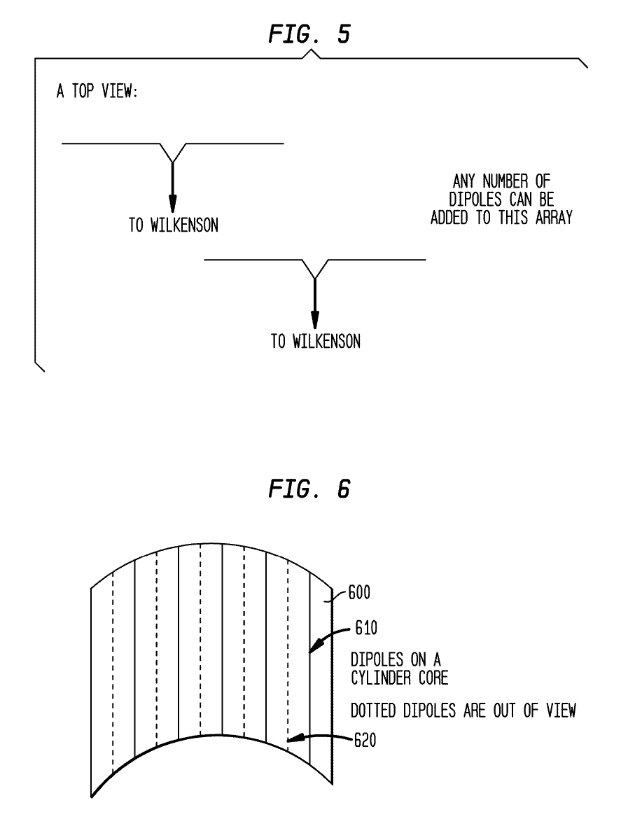

In Fig. 4A, a preferred embodiment is depicted where two half wavelength (λ/2) dipoles 410, 420 are arrayed together and their outputs are combined by a well-known Wilkinson type power combiner/divider. First dipole 410 is coupled to one input of RFIC 450 via the Wilkinson network, while second dipole 420 is coupled to the second input of RFIC 450. In an alternative embodiment shown in Fig. 4B, the system also includes a chip resistor 470. A rectangular spacer is used in the embodiments of Figs. 4A and 4B. However, it should be understood that other spacers such as a triangular or hexagonal array spacer may be used. The spacing between dipoles is greater than one-quarter wavelength (λ/4). For either embodiment to work properly, the dipoles must be phased so that they do not constructively add to one another, thereby permitting differential operation. It should be noted that the embodiment shown in Fig. 4A, does not require a microstrip line. Fig. 5 presents a top view of the system of Fig. 4A.

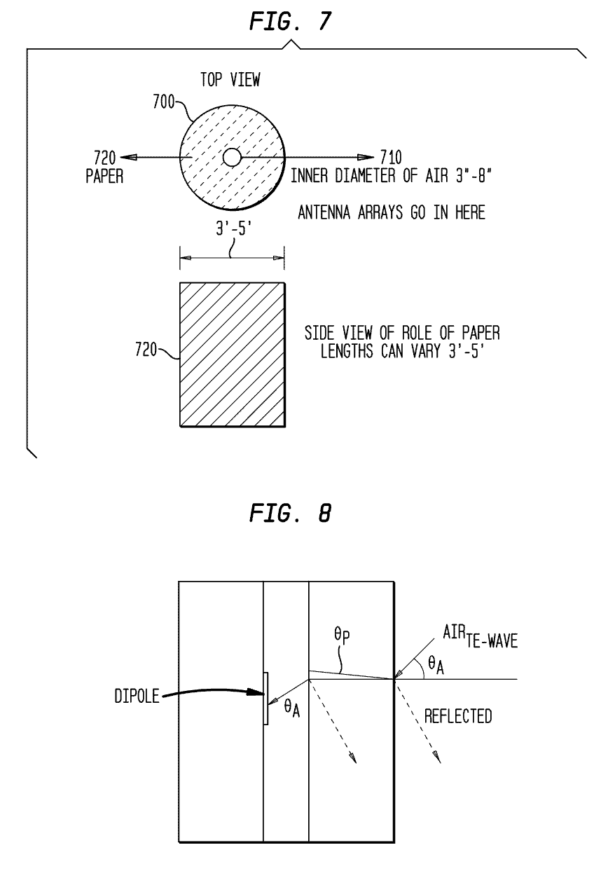

The present invention is particularly useful where inventoried items have a cylindrical shape. For example, in Fig. 6 an alternative embodiment is shown where vertical dipole antennas 610, 620 are arranged around a cylinder corresponding to a ring array around a core 600 such as would be employed for a roll of paper. Fig. 7 shows a practical application where a roll of paper 700 has a hollow core 710. Core 710 may be filled with air, foam, or dielectric material. Inserting or setting a ring array of vertical dipole antennas inside core 710, would significantly increase the spatial coverage area for an RFID system as described above. Moreover, proper phasing between antenna elements can improve the transmission of data as compared with a single dipole antenna.

EXAMPLEPaper has a dielectric loss factor of about 15 with a real permittivity of about 2.0. Considerable loss is created by the dielectric loss of paper. Additional loss is incurred by boundary impedance mismatches, Brewster angles, and the angle of incidence of the wave signal into the paper from the reader.

Mismatch of Impedances at the boundaries:Fig. 8 illustrates that, depending on the angle of incidence into the core from the reader, a certain portion of the wave signal will be reflected. Assuming a TE (transverse electric) field wave, a certain portion of the incident wave will be transverse magnetically. Snell"s law is used to calculate the angle of the reflected wave. The relationship between the dielectric is sufficient for calculating the reflection and transmission coefficients. A thorough analysis matching boundary conditions to modes, to internally generated modes would produce the desired information or a geometrical optics approach may be used.

The following observations are noted. Each reflected wave accounts for 0.5 dB power loss, which amounts to a loss of about 10% of the power at each boundary. The power loss at the paper to air boundary at the paper"s core varies according to which side the antenna is disposed on compared to the angle of incidence. On the same side as the incident wave, there is no loss due to impedance mismatches. On the opposite side there is about 0.5 dB loss each way, receiving and transmitting. The dielectric loss of paper is about 0.15: ê= 2.0 j x15, which at 900 MHZ equates to 1.25 dB/meter of loss.

The power that is lost by the factors indicated above demonstrates the need for additional antenna gain on the transponder side. The array of the present embodiment is believed to overcome this loss.

One Time Transmit of Passive RFID TagsWhile applications using non-planar configurations are useful in obtaining the proper gain of an RFID tag for using in various packaging configurations, there remain considerations as to whether to use a passive or active RFID tag, depending upon the application. In many applications where the tracking of a shipment or inventory is required, a passive RFID tag with low cost and long operational life may be more suitable than an active RFID tag running from a battery. However, when an item is lost or stolen or has become lodged in a location of a shipping container or a warehouse where the passive RFID tag transmitter is outside the range of reader, the need exists for an active RFID tag capability.

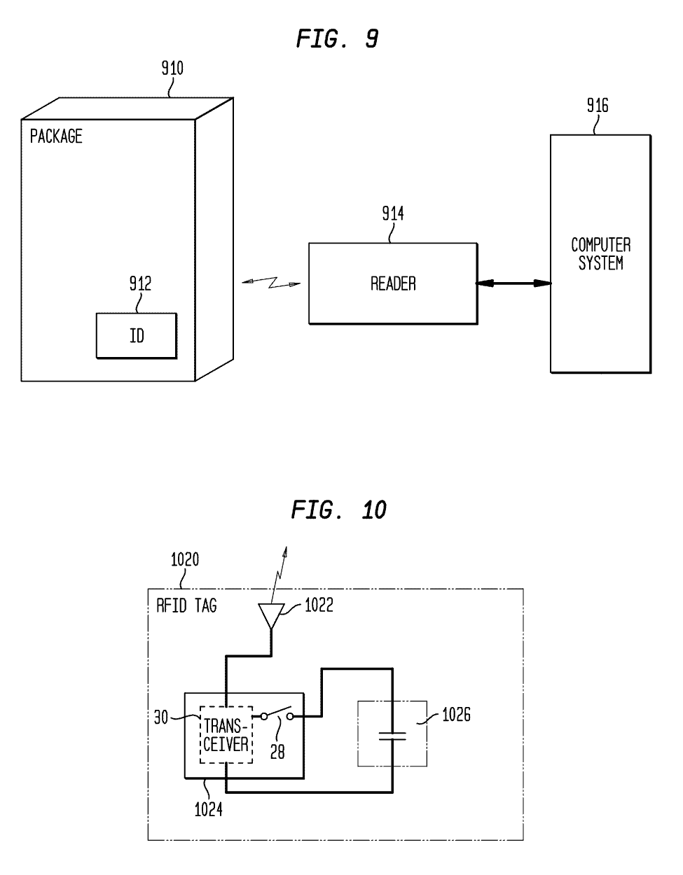

Advantageously, the present invention provides for an embodiment of the present invention with an RFID tag having a one time transmit capability. Referring to FIG. 9 there can be seen a functional overview of a system employing the present invention. A package 910 contains an identification tag 912. The identification tag 912 may be an RFID or other suitable identification tag 912. The identification tag 912 contains encoded data corresponding to a unique product identification, serial number, and history of the environmental conditions and location corresponding to the package 910. A reader 914 interrogates the identification tag 912. The interrogator 914 is coupled to a computer system 916.

Referring to FIG. 10 there can be seen a detailed functional overview the RFID tag with one time transmit capabilities. An RFID tag 1020 is comprised of an antenna 1022, a transponder 1024 and an energy storage device 1026. The RFID tag 1020 in response to being interrogated utilizes an energy storage device 1026 to transmit an active response to the interrogation. Portions of the RFID tag 1020, such as the antenna 1022 and the energy storage device 1026 may be printed on a package or label. The transponder 1024 can be an application specific integrated circuit (ASIC) or other suitable technology which is known to those stilled in the art. In response to a predetermined form or query or code the transponder 1024 couples a transceiver 1030 through a switch 1028 to the energy storage device1026. Thus the RFID tag can function as a passive system until a predetermined alert or security code is activated. Upon activation a higher power response to the interrogation is generated by the RFID tag 1020.

The energy storage device 1026 can be a capacitor storing electrical charge. The capacitor may be printed, or thin film technology. A reader 1014 can activate the RFID tag 1020 and receive a response at a greater distance than when the RFID tag 1020 operates in the passive mode. Greater data can be transferred than with a passive system. With a sufficient power level in the energy storage device 1026, a satellite reader/interrogator, such as one based on a LEO or GEO satellite system, can be utilized, thus enabling global trackingUsing a satellite system as the reader, a lost or stolen package can be signaled to emit a response.

Utilizing the selective one time active response from the RFID tag, valuable and stolen goods can be tracked. Multiple readers can be distributed to receive the response. Alternatively, a phased array utilizing digital beaming can be employed to home in on the product. Typical return power levels from passive RFID systems are 50dB below the input (interrogation) power.

The information provided by the RFID tag with one time transmit capability can be communicated to a remote computer system over the internet using wireless internet connection circuitry such as the type used in cellular telephones and DDA devices, thus enabling a shipper, manufacturer, security personnel or other concerned party to monitor and track the status and integrity of the package.

In view of the foregoing description, numerous modifications and alternative embodiments of the invention will be apparent to those skilled in the art. The energy storage device may be charged by a variety of methods including external application of power, chemical generation, and electrostatic discharge (such as from peeling a wrapper from the product label. Accordingly, this description is to be construed as illustrative only and is for the purpose of teaching those skilled in the art the best mode of carrying out the invention. Details of the structure may be varied substantially without departing from the spirit of the invention.

Claims

1.A wireless smart package assembly for use in the protection of a product, said assembly comprising:
a package having at least one sheet of material adapted to enclose said product;
said sheet having interior and exterior surfaces; and
an electrically conductive layer covering a portion of at least one of said surfaces of said sheet.

2.The assembly of claim 1 wherein said electrically conductive layer covers a non-planar region of said sheet and is adapted to form an antenna.

3.The assembly of claim 1 wherein:
said sheet is folded to form multiple interior and exterior surfaces to surround said product; and
said electrically conductive layer is adapted to traverse at least one fold and cover a portion of at least two surfaces.

4.The assembly of claim 3 wherein said electrically conductive layer is adapted to form an antenna and said layer is defined by a length and width along said surfaces in proportion to at least one property selected from the group consisting of size of said package, material used in said sheet, uses for said antenna, material properties of said product, and operating frequency of said antenna.

5.The assembly of claim 2 or 4 wherein said layer has a thickness defined proportionally to a selected range and a selected radiating efficiency.

6.The assembly of claim 2 or 4 wherein said antenna is adapted to receive excitation from a transceiver, said excitation being selected from the group consisting of linear and circular polarization.

7.The assembly of claim 2 or 4 wherein said antenna includes a 5% VSWR bandwidth.

8.The assembly of claim 7 wherein said VSWR bandwidth is increased by resistively loading said electrically conductive layer.

9.The assembly of claim 2 or 4 wherein said layer is printed onto said surfaces.

10.The assembly of claim 2 or 4 wherein said layer is formed from copper metalization.

11.The assembly of claim 2 or 4 wherein said layer is formed from a conductive ink.

12.A wireless smart package assembly for use in the protection of a product, said assembly comprising:
a package having a least one sheet of material folded to form multiple interior and exterior surfaces to surround said product; and
an electrically conductive layer adapted to traverse at least one fold and cover a portion of at least two surfaces to form a non-planar antenna.

13.The assembly of claim 12 wherein said electrically conductive layer is defined by a length and width along said surfaces in proportion to at least one property selected from the group consisting of size of said package, material used in said sheet, uses for said antenna; material properties of said product; and operating frequency of said antenna.

14.The assembly of claim 12 or 13 wherein said layer has a thickness defined proportionally to a selected range and a selected radiating efficiency.

15.The assembly of claim 12 or 13 wherein said antenna is adapted to receive excitation from a transceiver, said excitation being selected from the group consisting of linear and circular polarization.

16.The assembly of claim 12 or 13 wherein said antenna includes a 5% VSWR bandwidth.

17.The assembly of claim 16 wherein said VSWR bandwidth is increased by resistively loading said electrically conductive layer.

18.The assembly of claim 12 or 13 wherein said layer is printed onto said surfaces.

19.The assembly of claim 12 or 13 wherein said layer is formed from copper metalization.

20.The assembly of claim 12 or 13 wherein said layer is formed from a conductive ink.

21.The assembly of claim 13 wherein said at least one sheet is adapted with at least four surfaces to surround said product and said layer covers a portion of four of said surfaces.

22The assembly of claim 13 wherein sheet is or a two ply material and said layer is formed in between said two-ply layers.

23.The assembly of claim 13 including an RFID tag electrically connected with said layer.

24.A wireless smart package assembly for use in the protection and display of a product, said assembly comprising:
a package having a least one sheet of material folded and cut to form multiple interior and exterior surfaces to surround said product;
an electrically conductive layer adapted to traverse at least one fold and cover a portion of at least two surfaces to form a non-planar antenna; and
an RFID tag electrically connected with said layer.

25.A wireless smart package assembly for use in the distribution of a product, said assembly comprising:
a package having at least one sheet of material adapted to support the shipment and storage of a product; and
an electrically conductive material distributed along a portion of said sheet so as to form an non-planar antenna using said package.

26.The assembly of claim 25 wherein:
said package is adapted to surround said product;
said electrically conductive material is arranged to form a non-planar layer
aid sheet is folded to form multiple interior and exterior surfaces to surround said product; and
said electrically conductive layer is adapted to traverse at least one fold and cover a portion of at least two surfaces.

27.The assembly of claim 26 wherein said layer has a thickness defined proportionally to a selected range and a selected radiating efficiency.

28.The assembly of claim 26 wherein said antenna is adapted to receive excitation from a transceiver, said excitation being selected from the group consisting of linear and circular polarization.

29.The assembly of claim 12 or 13 wherein said antenna includes a 5% VSWR bandwidth.

30.The assembly of claim 16 wherein said VSWR bandwidth is increased by resistively loading said electrically conductive layer.

31.The assembly of claim 26 wherein said layer is printed onto said surfaces.

32.The assembly of claim 26 wherein said layer is formed from copper metalization.

33.The assembly of claim 12 or 13 wherein said layer is formed from a conductive ink.

34.The assembly of claim 25 wherein:
said product is a roll of paper;
said package is a cylindrical core having an inner surface surrounding a hollow center and an outer surface about which said paper is rolled;
said electrically conductive material is arranged to form a ring of spaced-apart linear dipoles about the circumference of said core
said dipoles are connected to a combiner circuit to form a dipole antenna array.

35.The assembly of claim 25, 26 or 34 including:
a passive RFID tag having a power source for a one-time transmit operation.
